(19) United States
(12) Patent Application Publication
(10) Pub. No.: US 2009/0239681 A1
(43) Pub. Date: Sep. 24, 2009

(54) IRON-TYPE GOLF CLUB HEAD AND METHOD FOR MANUFACTURING THE SAME

(76) Inventor: Yasushi SUGIMOTO, Kobe-shi (JP)

Correspondence Address: BIRCH STEWART KOLASCH & BIRCH, PO BOX 747, FALLS CHURCH, VA, 22040-0747, US

(21) Appl. No.: 12/343,157

(22) Filed: Dec. 23, 2008

(30) Foreign Application Priority Data
Mar. 24, 2008 (JP) 2008-076295

(51) Int. Cl. A63B 53/04; B23P 11/00

(52) U.S. Cl. 473/350; 473/349; 29/525.01

(57) ABSTRACT

An iron-type metal golf club head comprises: a main body including a hosel portion and a face plate portion having a back surface and a front surface forming a clubface; and a ring-shaped member disposed behind the face plate portion and having an outer periphery surface continuous in the circling direction of the ring. The ring-shaped member is made up of at least two segments parted by at least two parting planes, each parting plane extending crosswise to the circling direction of the ring-shaped member so as to form opposed sections of the adjacent segments. The segments include: a primary segment attached to the main body by welding along a first line and at least one of second lines; and a secondary segment attached to the main body by welding along the first line, wherein the first line is an intersection line of the above-mentioned outer periphery surface and the surface of the main body, and the second line is an intersection line of the back surface of the face plate portion and each of the sections of the segment.

### BACKGROUND OF THE INVENTION

The present invention relates to an iron-type golf club head and a manufacturing method therefor, more particularly to a segmented structure of a ring-shaped member disposed behind the clubface, and a method for welding the segments to the main body of the club head.

In the Japanese utility Model Patent 3,114,961, as shown in FIGS. 11(a) and 11(b), there has been proposed an iron-type golf club head (A1) composed of a main body (a) having a flat back surface (b), and a ring-shaped member (c) welded to the back surface (b) to form an open cavity (e) behind the clubface.

In such a club head structure, the interface between the main body (a) and the ring-shaped member (c) appears on the outer peripheral surface of the head as a line (Bo) and appears on the inner surface of the cavity (e) as a line (Bi). Thus, there is a possibility that the welding operation is made along the line (Bo) and line (Bi).

The welding along the line (BO) can be made from the outside of the head, therefore, the operation is easy. But, the welding operation along the line (Bi) is difficult because the cavity is narrow and restricts the movements of welding tools. Especially, when the so called pocket cavity CP as shown in FIG. 3 is formed, the welding operation along the line (Bi) becomes very difficult although such structure requires more joint strength between the main body and ring-shaped member in order to support the mass of the backside wall 14. Therefore, it is difficult to provide a sufficient joint strength if the welding is made along the line (Bo) only. Furthermore, in the case that the line (Bi) is easily visible as shown in FIG. 11(b), even if the welding can be made along the line (Bi), it is necessary to make finish polishing. But, such operation is difficult for the same reason as above.

### SUMMARY OF THE INVENTION

It is therefore, an object of the present invention to provide an iron-type golf club head and a manufacturing method therefor, in which the joint strength between the ring-shaped member and the head main body can be effectively increased without the need for the above-mentioned difficult operations.

According to the present invention, an iron-type metal golf club head comprises:

a main body including a hosel portion and a face plate portion having a back surface and a front surface forming a clubface; and

a ring-shaped member disposed behind the face plate portion and having an outer periphery surface continuous in the circling direction of the ring, wherein

the ring-shaped member is made up of at least two segments parted by at least two parting planes, each parting plane extending crosswise to the circling direction of the ring-shaped member so as to form opposed sections of the adjacent segments, and

the segments include: a primary segment attached to the main body by welding along a first line and at least one of second lines; and a secondary segment attached to the main body by welding along the first line but the second lines, wherein

the first line is an intersection line of the above-mentioned outer periphery surface and the surface of the main body, and

the second line is an intersection line of the back surface of the face plate portion and each of the sections of the segment.

### BRIEF DESCRIPTION OF THE DRAWINGS

FIG. 1 is a front view of an iron-type golf club head according to the present invention.

FIG. 2 is a rear view thereof.

FIG. 3 is a cross sectional view taken along line A-A in FIG. 1.

FIG. 4 is an exploded perspective view showing a first embodiment of the club head.

FIGS. 5(a) and 5(b) are perspective views for explaining a method for manufacturing the first embodiment of the club head according to the present invention.

FIG. 6 is a rear view of a second embodiment of the club head.

FIG. 7 is a rear view of a third embodiment of the club head.

FIGS. 8(a) and 8(b) are perspective views for explaining a fourth embodiment of the club head and a manufacturing method therefor.

FIG. 9 is an enlarged cross-sectional view showing an example of a welded portion taken along a perpendicular direction to the second line.

FIGS. 10(a) and 10(b) are enlarged cross-sectional views showing another example of a welded portion taken along a perpendicular direction to the second line.

FIGS. 11(a) and 11(b) are an exploded perspective view and a cross sectional view showing an iron-type golf club head according to the a prior art.

### DESCRIPTION OF THE PREFERRED EMBODIMENTS

Embodiments of the present invention will now be described in detail in conjunction with accompanying drawings.

In the drawings, iron-type golf club head 1 according to the present invention has a clubface 2 for striking a ball, a top face 3 intersecting the clubface 2 at an upper part of the clubface edge, a sole face 4 intersecting the clubface 2 at a lower part of the clubface edge, and a toe face 5 intersecting the clubface 2 at a toe-side part of the clubface edge and extending between the top face 3 and sole face 4. The top face 3 is inclined downward toward the heel from the toe. A major part of the sole face 4 extends substantially horizontally in the heel-and-toe direction. The toe face 5 is curved convexly towards the outside. The head 1 comprises a heel portion 6 provided with a tubular hosel portion 7 protruding upwardly therefrom and having a shaft inserting hole 7a into which a clubshaft (not shown) is inserted.

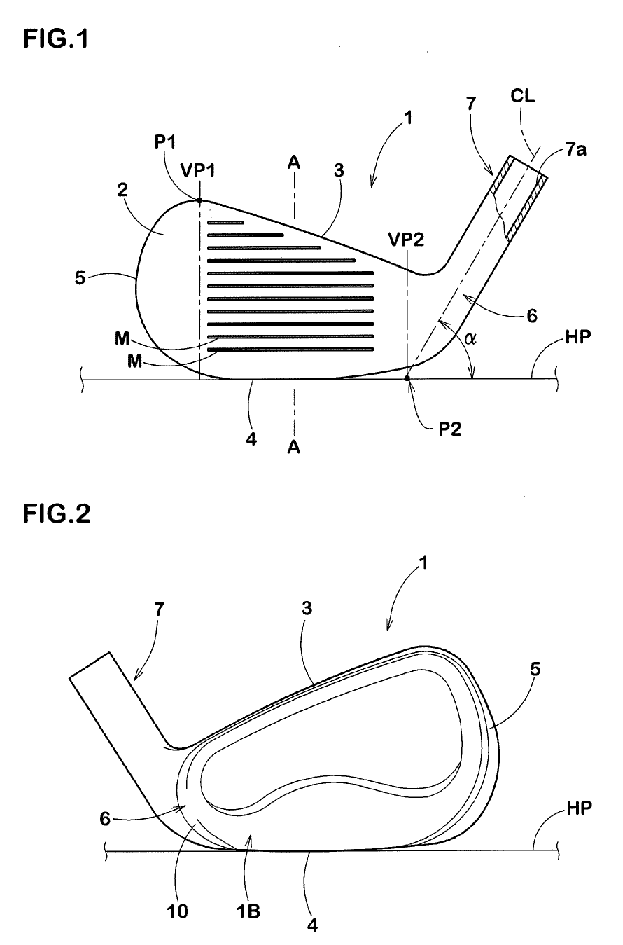

In this specification, positions, directions and the like relating to the club head refer to those under a standard state of the club head unless otherwise noted. Here, the standard state of the club head is such that the club head is set on a horizontal plane HP so that the center line CL of the club shaft (not shown) is inclined at the lie angle (alpha) while keeping the club shaft center line CL on a vertical plane, and the clubface forms its loft angle (beta) with respect to the horizontal plane HP. Incidentally, in the case of the club head alone, the center line of the shaft inserting hole can be used instead of the center line of the club shaft. As shown in FIG. 1, the above-mentioned top face 3 is defined as extending between vertical planes VP1 and VP2. The sole face 4 is defined as extending between the vertical planes VP1 and VP2. The toe face 5 is defined as existing on the toe-side of the vertical plane VP1. The heel portion 6 including the hosel portion 7 is defined as existing on the heel-side of the vertical plane VP2. The vertical plane VP1 is defined as being perpendicular to the clubface 2 and including the highest point P1 of the clubface 2. The vertical plane VP2 is defined as being perpendicular to the clubface 2 and including the intersecting point P2 of the center line CL and the horizontal plane HP.

The clubface 2 can be provided with so called impact area marking M, namely, small grooves extending horizontally to increase the frictional force between the ball and clubface 2 at impact. Otherwise, the clubface 2 is flat. Therefore, the edge of the clubface 2 can be determined as the edge of the flat surface.

The club head 1 is composed of a main body 1A and a ring-shaped member 1B which are welded to each other. Therefore, as shown in FIG. 2, an open cavity is formed behind the clubface 2.

The main body 1A is made of a single metal material which preferably has a specific gravity of not more than 10.0, more preferably not more than 9.0, still more preferably not more than 8.0, but not less than 2.0, more preferably not less than 3.0, still more preferably not less than 4.0, especially preferably not less than 4.5. For example, magnesium alloys, aluminum alloys, titanium alloys, stainless alloys, soft irons (or low-carbon steel whose carbon content is less than 0.3 wt %) and the like can be used suitably for such metal material.

The weight or mass of the main body 1A is preferably set in a range of not less than 120 grams, more preferably not less than 130 grams, but not more than 220 grams, more preferably not more than 210 grams, still more preferably not more than 200 grams.

The main body 1A integrally includes a face plate portion 8 and the above-mentioned hosel portion 7 on the heel-side of face plate portion 8.

The face plate portion 8 has the front surface which includes the entirety of the clubface 2 and the back surface 8b which is a single flat surface, and the thickness of the face plate portion 8 is substantially constant.

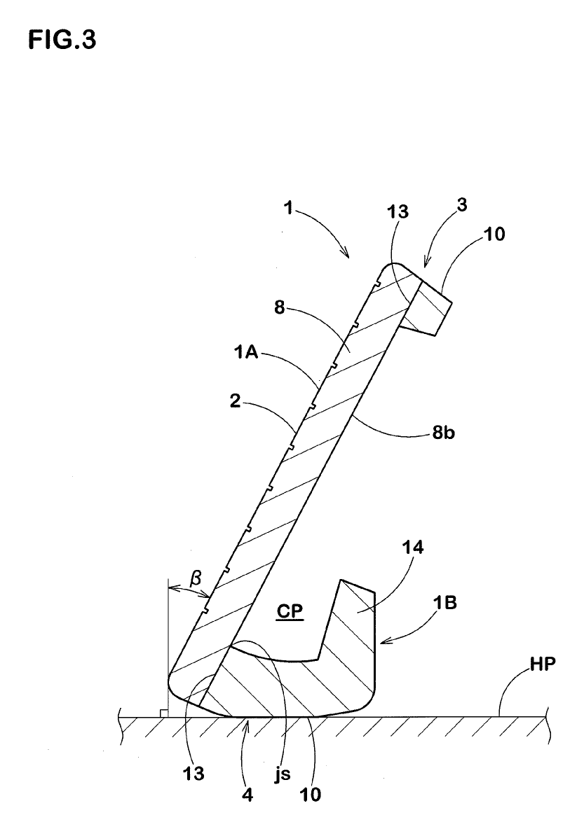

The ring-shaped member 1B is provided at the front thereof with an engaging surface 13 which is a flat surface capable of closely contacting with the back surface 8b of the face plate portion 8. In the closely contact state, the ring-shaped member 1B is welded to the back surface 8b so that it has a continuous annular outer periphery surface 10 which surface 10 forms rear parts of the above-mentioned top face 3, toe face 5 and sole face 4, respectively, and a rear part of the outer surface of the heel portion 6, as shown in FIG. 2 and FIG. 3.

In the following embodiments, the ring-shaped member 1B is provided with a backside wall 14 in order to deepen the center of gravity of the head. The backside wall 14 extends upwardly from the sole face 4, while leaving a space from the back surface 8b of the face plate portion 8, therefore, a pocket cavity CP is formed between the face plate portion 8 and the backside wall 14. The backside wall 14 is formed along only the sole face 4, but it is also possible to form the backside wall along the entire circumference of the ring-shaped member 1B, or along the sole face 4 and the top face 3, or any suitable combination.

In order to deepen the center of gravity of the head and to increase the moment of inertia, the total mass of the ring-shaped member 1B is preferably set in a range of not less than 70 grams, more preferably not less than 80 grams, still more preferably not less than 90 grams, but not more than 130 grams, more preferably not more than 120 grams, still more preferably not more than 110 grams. If the total mass is less than 70 grams, the depth of the center of gravity and the moment of inertia become decreased, and as a result, directionality of the hit balls tends to become worse. If more than 130 grams, the weight available for the main body 1A is relatively decreased, and as a result, it becomes necessary to downsize the head or the weight balance of the head becomes worse.

According to the present invention, the ring-shaped member 1B is, before welded to the main body 1A, made up of at least two separate segments 12 which are parted by at least two parting planes each extending crosswise to the circling direction C of the ring. Accordingly, the segments 12 each have two sections 11 one on each side in the circling direction C.

Each of the segments 12 is made of a metal material having a specific gravity which is in a range of not less than 5.0, preferably not less than 6.0, more preferably not less than 7.0, but not more than 20.0, preferably not more than 18.0, more preferably not more than 15.0. For example, aluminum alloys, titanium alloys, stainless alloys, tungsten alloys and the like can be used. Thus, the ring-shaped member 1B as a whole can be made of a singe metal material or alternatively plurality kinds of different metal materials. Preferably at least one of, more preferably each of the segments 12 has a specific gravity larger than that of the main body 1A. In this case, it is preferable that the difference in the specific gravity from the main body 1A is not less than 1.0, more preferably not less than 2.0, still more preferably not less than 3.0, but not more than 10.0, more preferably not more than 9.0, still more preferably not more than 8.0.

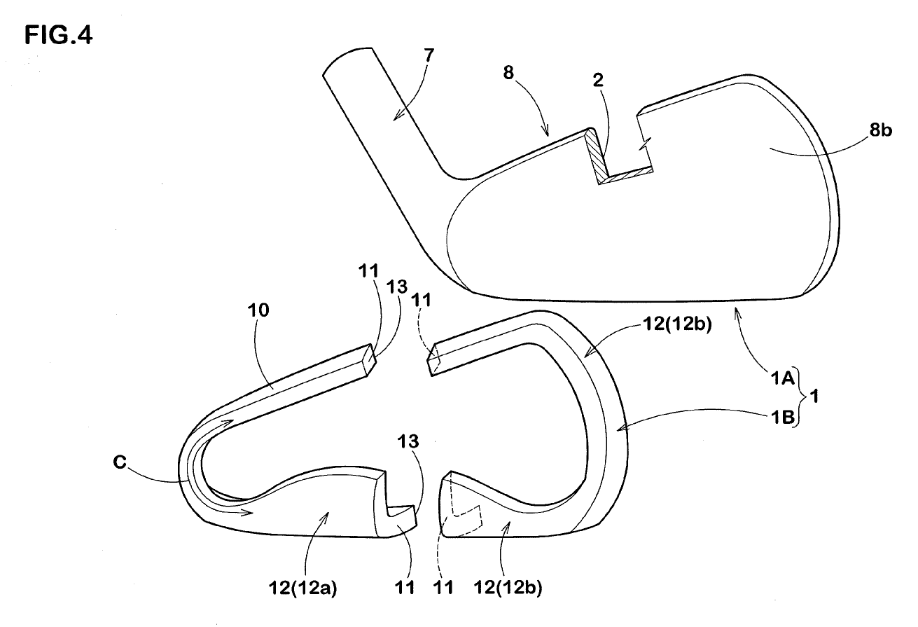

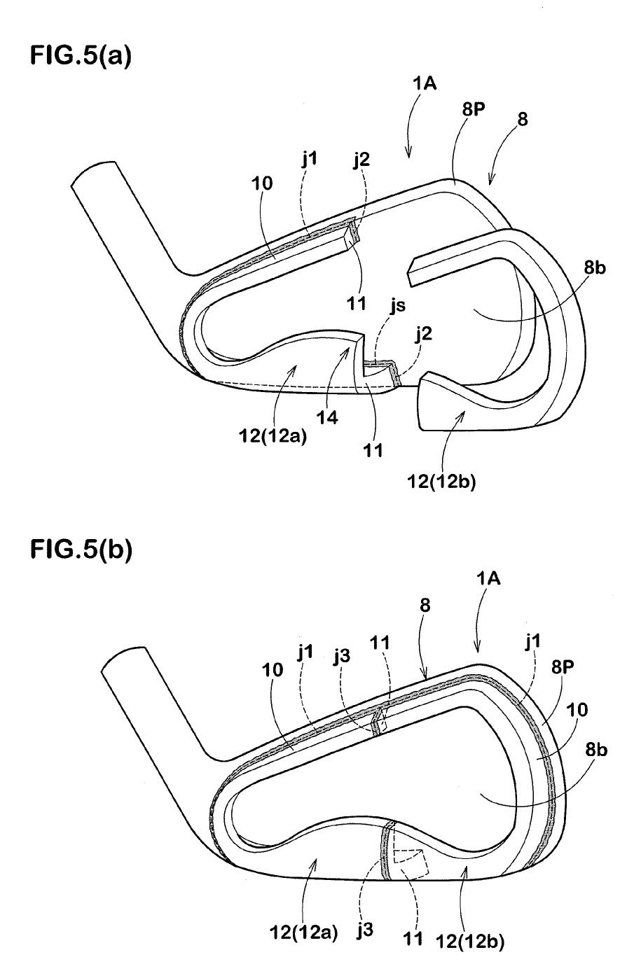

FIGS. 4, 5(a) and 5(b) show a first embodiment made up of two segments 12 parted by two parting planes.

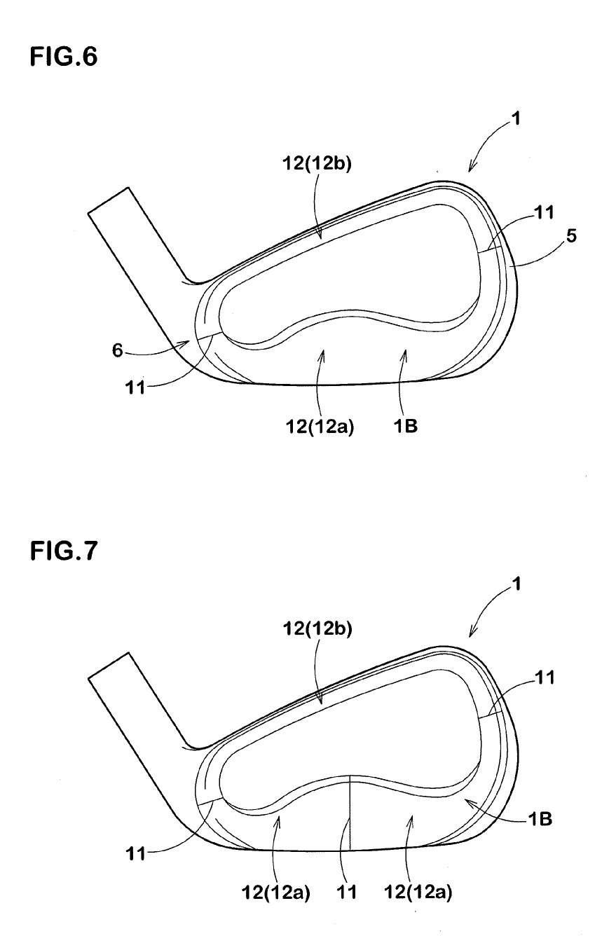

FIG. 6 shows a second embodiment made up of two segments 12 parted by two parting planes.

FIG. 7 shows a third embodiment made up of three segments 12 parted by three parting planes.

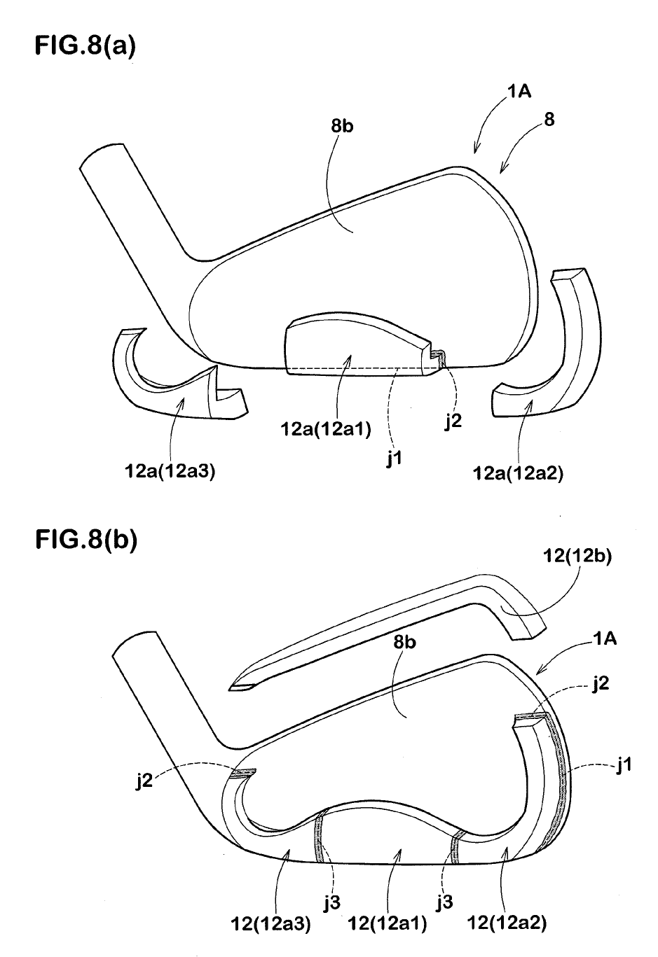

FIGS. 8(a) and 8(b) show a fourth embodiment made up of four segments 12 parted by four parting planes.

It is preferable that the number of the segments 12 is not more than 8, more preferably not more than 7, still more preferably not more than 6 since the production efficiency is lowered with the increase in the number of the segments.

According to the present invention, the segments 12 can be classified into primary segments 12a and secondary segments 12b by the positions of the segment welded to the main body 1A. Specifically, the primary segment 12a is defined as being welded to the main body 1A along both of a first line j1 and a second line j2. The secondary segment 12b is defined as being welded to the main body 1A along the first line j1 but the second line j2. Here, the first line j1 is the intersection line of two surfaces which are the periphery surface 10 of the ring-shaped member 1B and the outer surface of the main body which is the periphery surface 8P of the face plate portion 8 in the 1st to 4th embodiments. The second line j2 is the intersection line of two surfaces which are the back surface 8b of the face plate portion 8 and each of the sections 11 (parting planes).

Each of the segments 12 has two second lines j2 since there are two sections 11 (or parting planes) one on each side thereof. In the case of the primary segment 12a, the welding is made along at least one of the two second lines j2. In the case of the secondary segment 12b, the welding is made along neither one of nor both of the two second lines j2.

The expression “welding along the line j1/j2” means that the welding is made continuously or discontinuously along the line, more specifically, the welding is made continuously along the entire length of the line or the welding is made at certain intervals along the entire length of the line.

The sole face 4 is very liable to be subjected to a large impulsive force when contacting the ground during swing, therefore, it is preferable that the primary segment 12a forms at least a part of the sole face 4 in order to increase the joint strength between the segment and the main body and thereby to improve the durability of the head.

As the segment 12 becomes heavier, a larger joint strength is required, therefore, it is preferable that the weight of the primary segment 12a which can exert a larger joint strength is increased more than the secondary segment 12b, whereby the joint strength of the ring-shaped member 1B as a whole can be improved well-balancedly to further improve the durability.

In the first embodiment shown in FIGS. 4, 5(a) and 5(b), the two parting planes (sections 11) are substantially-vertical flat planes extending at such positions that substantially bisect the ring-shaped member 1B in the heel-and-toe direction. In this example, the heel-side segment is the above-mentioned primary segment 12a.

In the second embodiment shown in FIG. 6, the two parting planes (sections 11) are substantially-flat planes extending across a midpoint of the toe and a midpoint of the heel such that the ring-shaped member 1B is divided into an upper segment and a lower segment. In this example, the lower segment is the primary segment 12a. The lower segment forms the entirety of the sole face 4 and is heavier than the upper segment.

In the third embodiment shown in FIG. 7, the above-mentioned lower segment shown in FIG. 6 is further divided into two parts, and the third parting plane (sections 11) is a substantially-vertical flat plane extending at such a position that substantially bisects the lower segment in the heel-and-toe direction. In this example, the toe-side and heel-side segments or parts divided from the lower segment are the primary segment 12a.

In the fourth embodiment shown in FIGS. 8(a) and 8(b), the lower segment shown in FIG. 6 is further divided into three parts, and the third and fourth parting planes (sections 11) are substantially-vertical flat planes extending at such positions that substantially trisect the lower segment in the heel-and-toe direction. In this example, each of the segments or parts divided from the lower segment are the primary segment 12a.

The method for manufacturing the club head 1 according to the present invention will now be described in detail, mainly taking the first embodiment as an example, in conjunction with FIG. 5(a) and 5(b).

Firstly, the main body 1A and the segments 12 are prepared. Various methods may be employed in order to make these metal parts. In view of the production efficiency, casting, forging and/or press molding are preferred.

In the first embodiment, it is possible to treat one of the two segments 12 on the heel-side as the primary segment 12a, and the segment 12 on the toe-side as the secondary segment 12b as mentioned above. As shown in FIG. 5(a), the primary segment 12a is fixed to the main body 1A by welding these two parts along the first line j1 and the two second lines j2. In this example, the welding is made continuously along the entire length of the first line j1 and along the entire length of each of the second lines j2.

Because the first line j1 appears on the outer surface of the club head 1, the welding operation can be made from the outside of the head and, thus the operation is easy. Also the second line j2 appears on the back surface 8b of the face plate portion 8 which is exposed to the outside of the head and thus easily accessible, therefore, the welding operation along the second line j2 can be made from the outside of the head and, thus, this operation is also easy.

As to the sequence of the welding operation, it is possible to weld along the first line j1 ahead of the second line j2 or vice versa.

The primary segment 12a is thus fixed to the main body 1A.

Next, in the case of the first embodiment, the secondary segment 12b is fixed to the main body 1A, as shown in FIG. 5(b). Firstly, the secondary segment 12b is set such that the sections 11 thereof are substantially fitted to the sections 11 of the primary segment 12a, and thereby the welded portions along the second lines j2 of the primary segment 12a are hidden by the secondary segment 12b.

Then, the secondary segment 12b is welded along the first line j1. In this example, the welding is made continuously along the entire length of the first line j1.

Incidentally, during welding, in order to prevent displacement of the segments 12a and 12b from the main body 1A, an adhesive and/or a device, e.g. clamp, holder or the like can be used for temporarily fixation.

As to the kinds of welding, various welding methods, for example, TIG welding, plasma welding, laser welding and the like can be employed, but in order to prevent the formation of unfavorable large weld beads, plasma welding or laser welding is preferably employed.

In some combinations of metal materials where it is difficult to join one metal material directly to the other metal material (for example, titanium alloy and stainless alloy, magnesium alloy and stainless alloy, titanium alloy and tungsten alloy), an intermediate or filler metal can be used to join such materials each other. As understandable from this, what is called “soldering” can be employed as the welding in a broad sense.

Optionally, further welding which can be made from the outside of the club head, is made along an intersection line j3 of the outer surfaces of the adjacent segments 12 (or a small gap (j3) between the opposed sections 11 thereof).

Furthermore, it is possible to make welding along an intersection line which is substantially invisible after the completion of the head but easily accessible during assembling the head. An example of such invisible intersection line is shown in FIG. 5(a) as line “js”. This intersection line “js” is that of the back surface 8b of the face plate portion 8 and the inner circumferential surface of the segment 12 (12a), and the line “js” is hidden behind the backside wall 14 in the backside view of the club head 1 under the standard state. In such case, as the welded part is located in a blind spot, the finishing work such as polishing for improving the appearance can be omitted to increase the manufacturing efficiency.

In the case of the ring-shaped member 1B made up of three or more segments 12, it is preferable that one of the segments 12 is the secondary segment 12b and all of the remaining segments 12 are the primary segment 12a.

For example, in the fourth embodiment shown in FIGS. 8(a) and 8(b), one of the four segments 12 is the secondary segment 12b, and the remaining tree segments 12 are the primary segment 12a (12a1, 12a2, 12a3).

The lower middle primary segment 12a1 which forms the rear middle part of the sole face 4 is liable to be subjected to large impulsive forces, therefore, it is preferable that the welding is made along the first line j1 and both of the two second lines j2, more preferably further along the hidden line The toe-side primary segment 12a2 which partially forms the sole face 4 and toe face 5, is connected to the lower middle primary segment 12a1 in the sole, and welded along the third line j3, the first line j1, and one of the second lines j2 located in the toe.

The heel-side primary segment 12a3 which forms partially the sole face 4 and heel portion 6, is connected to the lower middle primary segment 12a1 in the sole, and welded along the third line j3, the first line j1, and one of the second lines j2 located in the heel.

After all of the primary segment 12a (12a1, 12a2, 12a3) are welded to the main body 1A, the only one secondary segment 12b which forms the rear part of the top face 3, is welded along the first line j1 and the two third lines j3.

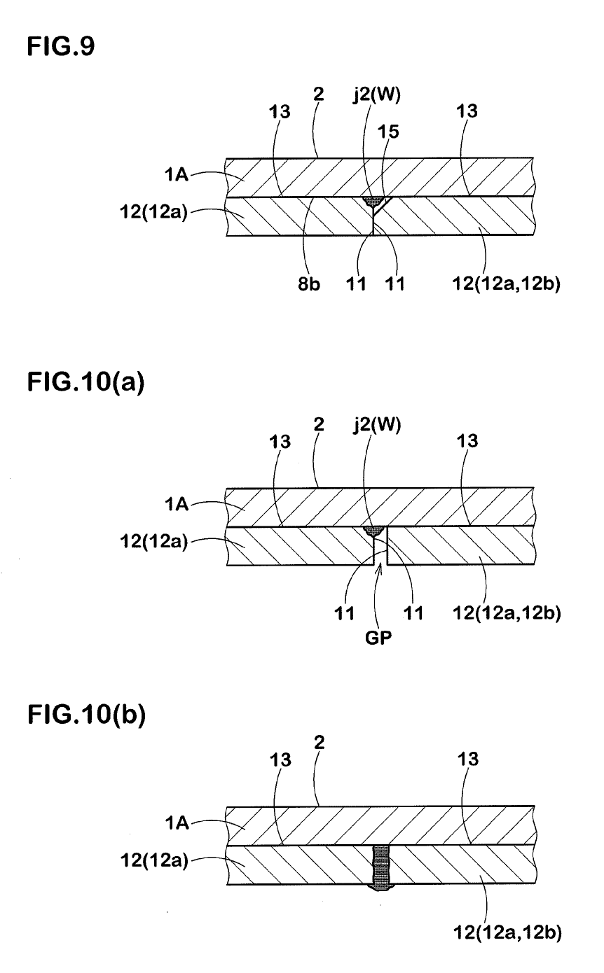

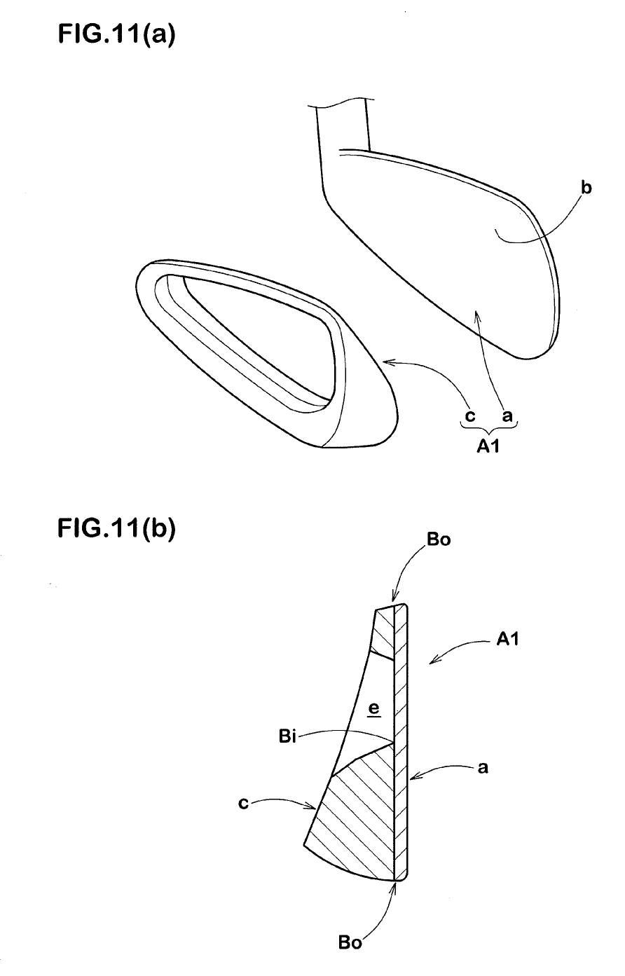

In either case, as shown in FIG. 9, in order to prevent the weld bead w formed along the second line j2 of the primary segment 12a from contacting with the section 11 of the adjacent segment 12 (12a, 12b), it is possible to chamfer the corner 15 between the section 11 and the engaging surface 13 of the afterward welded segment 12. Such chamfering of the corner 15 is especially preferable in the case of TIG welding where the size of the weld bead w is liable to become increased.

On the other hand, as shown in FIG. 10(a), it is also possible to position the afterward welded segment 12 such that a certain small gap Gp is intentionally formed between the adjacent sections 11 in order to prevent the weld bead w from contacting with the opposed section 11. In this case, the gap Gp functions like a groove during making so called groove welding, and the molten metal fills and bridges the gap as shown in FIG. 10(b).

Upon the completion of the welding of the final segment, the weld bead or weld line arising on the outer surface of the club head along the first line j1 and third lines j3 is final polished to improve the appearance of the club head. As to the second line j2 and intersection line “js”, it is not necessary to make finish polishing.

### Comparison Tests

Five-iron's heads (loft 26 degrees, weight 240 grams) were prepared and tested for the durability.

All of the heads had the same structure shown in FIGS. 1-3, excepting the parting and welding of the ring-shaped member. The main body (weight 140 grams) was manufactured by precision casting from a stainless steel (SUS630, specific gravity 7.8). The ring-shaped member (weight 100 grams) was manufactured by precision casting from a single material, tungsten alloy (W:Fe:Ni=35:40:15 in weight %, and specific gravity of 10.0). In order to weld these parts, TIG welding was employed. The specifications of the heads are shown in Table 1.

In the durability test, the club heads were attached to identical FRP shafts (“MP-400” manufactured by SRI Sports Limited) to make 38-inch five-iron clubs, and each club was mounted on a swing robot and hit golf balls 10,000 times (maximum) at the head speed of 40 m/s, while visually checking the club head every 100 times. If any damage was occured, the number of hits was recorded. The test results are shown in Table 1.

TABLE 1

| Head | Ref. 1 | Ex. 1 | Ex. 2 | Ex. 3 | Ex. 4 |
|---|---|---|---|---|---|
| Ring-shaped member | | | | | |
| Structure | — | Fig. 6 | Fig. 5 | Fig. 7 | Fig. 8 |
| Number of segments | — | 2 | 2 | 3 | 4 |
| Durability | | | | | |
| Number of hits | 1800 | 7000 | 8000 | 10000 | 10000 |
| Damage | yes *1 | yes *1 | yes *1 | no | no |

*1 Ring-shaped member was separated from Main body in Sole region

From the test results, it was confirmed that the heads according to the present invention can be remarkable improved in the durability.

1. An iron-type metal golf club head comprising:
a main body including a hosel portion and a face plate portion having a back surface and a front surface forming a clubface; and
a ring-shaped member disposed behind the face plate portion and having an outer periphery surface continuous in the circling direction of the ring, wherein
the ring-shaped member is made up of at least two segments parted by at least two parting planes, each said parting plane extending crosswise to the circling direction of the ring-shaped member so as to form opposed sections of the adjacent segments, and
said at least two segments include: a primary segment attached to the main body by welding along a first line and at least one of second lines; and a secondary segment attached to the main body by welding along the first line, wherein
the first line is an intersection line of said outer periphery surface and the surface of the main body, and
the second line is an intersection line of the back surface of the face plate portion and each of the sections of the segment.

2. The golf club head according to claim 1, wherein
the ring-shaped member is provided with a backside wall extending upwardly from a sole of the head, while leaving a space from the back surface of the face plate portion so as to form a pocket cavity.

3. The golf club head according to claim 2, wherein
at least one of the parting planes extends across the backside wall.

4. The golf club head according to claim 3, wherein
the primary segment forms at least a part of the backside wall.

5. The golf club head according to claim 1, wherein
the ring-shaped member is made up of one primary segment and one secondary segment.

6. The golf club head according to claim 1, wherein
the ring-shaped member is made up of at least two primary segments and only one secondary segment.

7. The golf club head according to claim 1, wherein
the primary segment forms at least a part of a sole of the head.

8. The golf club head according to claim 1, wherein
the mass of the primary segment is larger than the mass of the secondary segment.

9. The golf club head according to claim 1, wherein
the specific gravity of the primary segment is larger than that of the secondary segment.

10. The golf club head according to claim 1, wherein
between the sections of the adjacent segments, there are gaps filled with a filler metal.

11. The golf club head according to claim 1, wherein
the ring-shaped member is made of a single metal material, and
the main body is made of a metal material different from that of the ring-shaped member.

12. The golf club head according to claim 11, wherein
the specific gravity of the ring-shaped member is larger than that of the main body.

13. The golf club head according to claim 1, wherein
the ring-shaped member is made of plural kinds of metal materials.

14. A method for manufacturing the iron-type metal golf club head set forth in claim 1, comprising the steps of:
preparing the main body,
preparing the segments,
making the ring-shaped member by welding the segments to the main body,
wherein
the welding of the segments includes
firstly welding a primary segment, and
finally welding a secondary segment, and further when the number of the segments is more than two,
welding one or more remaining segments as a primary segment.

15. The method according to claim 14, which further comprises:
welding along intersection lines (j3) of the outer surfaces of the adjacent segments.
